(19) United States
(12) Patent Application Publication
(10) Pub. No.: US 2016/0288731 A1
(43) Pub. Date: Oct. 6, 2016

(54) MOUNTING DEVICE FOR VEHICLE

(71) Applicant: Joonho OH, Gyeonggi-do (KR)

(72) Inventor: Joonho OH, Gyeonggi-do (KR)

(21) Appl. No.: 15/103,651

(22) PCT Filed: Dec. 5, 2014
(86) PCT No.: PCT/KR2014/011880

§ 371 Date: Jun. 10, 2016

(30) Foreign Application Priority Data
Dec. 12, 2013 (KR) 10-2013-0155008

(51) Int. Cl. B60R 11/02

(52) U.S. Cl. CPC B60R 11/02; B60R 2011/0008

(57) ABSTRACT

The present invention relates to a mounting device for a vehicle. The mounting device for a vehicle according to an embodiment of the present invention is characterized by comprising: a detachably mounted supporting portion disposed to be inserted and supported when installed on a ventilation grill, having a portion disposed at the rear side of the ventilation grill and projecting toward the front side at the bottom and inserted and supported on the ventilation grill and projecting toward the rear side at the top; a detachably mounted pressing portion disposed to intersect with the detachably mounted supporting portion so as to move by sliding vertically and coupled to the detachably mounted supporting portion to be moved by sliding, having a front side projecting on a top portion facing the detachably mounted supporting portion so as to press the ventilation grill, and having a rear side projecting on a bottom portion facing the detachably mounted supporting portion, so as to be provided in a configuration in which the front side and the rear side that are coupled in a sliding manner intersect and face each other; a resilient portion disposed to resiliently support the detachably mounted supporting portion and the detachably mounted pressing portion against each other, resiliently supporting portions on the rear sides of the detachably mounted supporting portion and the detachably mounted pressing portion that project vertically, and imparting a pressing force to the front side of the detachably mounted pressing portion to press against the ventilation grill; and a mounting portion disposed on the front side of the detachably mounted pressing portion, and provided to be detachable and mountable through insertion into the detachably mounted pressing portion.

### CROSS REFERENCE TO RELATED APPLICATION

This application claims the benefit of and priority to PCT/KR2014/011880 filed on Jun. 12, 2015, entitled (translation), “MOUNTING DEVICE FOR VEHICLE,” which claims the benefit of and priority to Korean Patent Application No. 2013-0155008, filed on Dec. 12, 2013, all of which are hereby incorporated by reference in their entirety into this application.

### BACKGROUND

1. Field of the Invention

Embodiments of the present invention relate to a mounting device for a vehicle, and in particular to a mounting device for a vehicle, wherein it can be substantially, easily and detachably engaged to a ventilation grill via a user's simple manipulation, wherein the aforementioned mounting device for a vehicle can be mounted via one manipulation, thus enhancing convenience when in use and increasing a mounted strength.

2. Description of the Related Art

A vehicle may be called a driving equipment which is driven by a driver's manipulation to go to a predetermined destination. The driver should pay great attention since it needs to continuously manipulate his vehicle based on a road condition while looking at other nearby vehicles in a state where the driver has fully understood a route to a destination. If the driver drives the vehicle without looking at nearby surroundings, a possibility that the vehicle deviates out of the route to a destination or the vehicle collides with another vehicle or person will rise.

Moreover, in recent years, a cellular phone or various portable display devices are available during the driving thanks to the development of a wireless communication, and a navigation device is developed and is widely being used, which device may allow to recognize the current position in response to a satellite signal, thus providing a route information, a road condition information, etc., which are necessary for the driving of a vehicle, to a driver.

If the aforementioned device, for example, a cellular phone, various portable display devices, a navigation device, etc. is actually used at a vehicle, it should be mounted, using a mounting device, to collect an operation information necessary for a driving and an information necessary for a driver while minimizing a driver's attention distribution in a state that the driver can look at such information during the driving since the device is stably mounted by the mounting device.

Moreover, the mounting device is installed for the aforementioned electronic devices as well as various functional devices, for example, a cup holder, an air freshener, etc. to be supported stable inside of the vehicle.

The conventional mounting device for a vehicle, in general, is hung on a dashboard of a vehicle with the aid of an adhering force of a double-sided adhesive member, thus holding a predetermined mounted thing inside of the vehicle. The mounting device which uses a double-sided adhesive member, may lose an adhering force if the dashboard on which the device will be hung, is formed corrugated. For this reason, the mounting device may be easily detached from the dashboard in case of a sudden stop or against a light external impact.

In particular, if a mounted thing is detached in the direction of the driver, the driver's attention may be distributed or the driver may receive a predetermined physical impact, for which a predetermined accident may occur during the driving.

Moreover, since the conventional technology uses a double-sided adhesive member, it is hard to detach the mounting device since an adhering force still remains effective, and even after the mounting device has been removed, an adhesive residue may remain, which may contaminate the inside of the vehicle.

In recent years, a new mounting device for a vehicle has been developed in a clamp type, which fits with interference into a ventilation grill through which an external air, an air conditioned air or a heated wind inputs. Since this device is engaged detachable in such a way to forcibly pressing the mounting device into the ventilation grill, it is easier to detach the mounting device than the adhering method, and any residue does not remain after it has been detached, thus preventing any contamination inside of the vehicle.

The conventional mounting device of a clamp type, however, is engaged through an interference fit method, and it should be detached by applying a predetermined force strong enough to remove the interference fit. So, an over force should be inevitably applied against a ventilation grill formed of a plurality of thin bars when it needs to mount or demount. In this case, the ventilation grill may be broken due to over force.

Moreover, since the aforementioned mounting device is mounted or demounted by means of an interference fit method, if the clamping force which is necessary for the interference fit, is weak, the mounting device can be easily detached or attached, but it may be easily detached by an external impact. If the clamping force is strong, it is impossible for a weak person to detach or attach the mounting device.

### SUMMARY

Accordingly, embodiments of the present invention is made in an effort to resolve the aforementioned problems. Embodiments of the present invention provide a mounting device for a vehicle, wherein it can be substantially, easily and detachably engaged to a ventilation grill via a user's simple manipulation, wherein the aforementioned mounting device for a vehicle can be mounted via one manipulation, thus enhancing convenience when in use and increasing a mounted strength.

Embodiments of the present invention are not limited thereto, and other embodiments of the present invention, which were not mentioned above, may become apparent to a person having ordinary skill in the art from the following descriptions.

According to at least one embodiment, there is provided a mounting device for a vehicle which is installed at a ventilation grill of a vehicle to mount a predetermined mounted thing, which may include, but is not limited to, a detachably mounted support part which is disposed to be inserted and supported when the detachably mounted support part is installed at the ventilation grill, and it positions at the other side of the ventilation grill, and a portion protruding in the direction of one side at a lower portion thereof is inserted and supported in the ventilation grill, wherein the detachably mounted support part is provided protruding in the direction of the other side at the top thereof; a detachably mounted pressing part which is disposed to slide upward or downward, while intersecting with the detachably mounted support part, and is engaged to slide with the detachably mounted support part, wherein one side thereof is protruding to press the ventilation grill at the top which is opposite to the detachably mounted support part, and it is slide-engaged protruding at a lower portion which is opposite to the detachably mounted support part at a lower portion in the direction of the other side, so one side and the other side thereof are disposed intersecting each other to be opposite to the detachably mounted support part; an elastic part which is disposed elastically supporting the detachably mounted support part and the detachably mounted pressing part, while elastically supporting a portion which protrudes upward or downward of the other sides of the detachably mounted support part and the detachably mounted pressing part, whereby one side of the detachably mounted pressing part allows to provide a pressing pressure which presses the ventilation grill; and a mounting part which is disposed at one side of the detachably mounted pressing part, and is provided at the detachably mounted pressing part in such a way to be detached or attached by means of insertion, thus mounting a predetermined mounted thing.

According to at least one embodiment, the detachably mounted support part may include a support body which is disposed at one side when it is installed at the ventilation grill and is inserted inside of the detachably mounted pressing part and is able to slide upward or downward; a slide protrusion which is formed protruding at both sides of the support body and protrudes to guide the upward or downward movements as it is inserted in the detachably mounted pressing part at both sides of the support body; a support bracket which is disposed protruding in the direction of other side at a lower portion of the support body, wherein the other side direction thereof is open, and one side and upper and lower sides thereof are closed, thus forming a support space to be inserted and supported when it is installed at the ventilation grill; an elastic support bracket which is disposed protruding in the direction of one side at the top of the support body and positions at the top of the elastic part and is elastically supported, wherein the elastic support bracket has an elastic insertion hole formed in the center thereof, while passing through for the elastic part to be inserted, and the top thereof is fixed; and an elastic support member which is protruding in the downward direction of the elastic support bracket and is configured to cover a part of the top at an outer circumference of the elastic part, thus preventing an outward separation thereof.

According to at least one embodiment, there is provided a support protrusion which is formed protruding inside of the support bracket, and protrudes in the direction to be opposite to each other above and below inside of the support space, wherein a protruding portion is hooked and supported when inserting it into the ventilation grill, thus preventing any separation while enhancing a supporting force.

According to at least one embodiment, the detachably mounted pressing part may include a pressing body which is disposed at one side when it is installed at the ventilation grill, and has an accommodation space, the top of which is open, wherein the mounting part is inserted and supported at a part of the inside thereof, and an accommodation insertion groove into which a part connected with the mounting part is inserted, is formed at one side of the accommodation space, with a part thereof being open in the direction of one side, and a slide space a part of which is formed passing through from bottom to top, is formed, wherein the detachably mounted support part is inserted therein to slide upward or downward, and a groove shaped slide groove is provided, into which the detachably mounted support part is inserted, so as to guide it moves upward or downward at both sides which are opposite to each other in the slide space, and a pressing bracket which is disposed protruding in the direction of the other side at the top of the pressing body and positions at the top which is opposite to the other side of the detachably mounted support part and slides upward or downward together with the pressing body and is configured to be inserted, pressed and supported in the ventilation grill with the aid of an elastic force of the elastic part, wherein a pressing space is formed at the lower surface thereof, and the lower side thereof is open, and both sides and upper side thereof are closed, and the ventilation grill is inserted into the pressing space; a pressing operation member which is disposed protruding in the direction of one side thereof at a lower portion of the pressing body, and positions at a lower portion which is opposite to one side of the detachably mounted support part and slides upward or downward together with the pressing body, and is elastically supported by a lower portion of the elastic part, wherein the pressing operation member is able to generate a pressing pressure which allows to press downward the pressing bracket; and an operation bracket which is disposed protruding in the upward direction of the pressing operation member, wherein the operation bracket is able to prevent a separation to the outside since it covers a part of a lower portion of the outer circumference of the elastic part.

According to at least one embodiment, the slide protrusion may allow to form a protrusion inclination part which is inclined for the cross section area to be contracted in the direction from the other side to one side, and a groove inclination part may be formed at the slide groove into which the slide protrusion of the pressing body is inserted, wherein the cross section area increases in the direction from the other side to one side while matching with the protrusion inclination part. When the support body is slide-engaged to the pressing body, the protrusion inclination part becomes matched with the groove inclination part, so the slide protrusion can press the slide groove from the other side to one side, whereby it can be directly inserted and installed.

According to at least one embodiment, the elastic part may include an elastic member which is disposed to elastically support a portion which protrudes at one side of each of the detachably mounted support part and the detachably mounted pressing part and is able to generate a pressing force which allows to press the detachably mounted pressing part which is slide-engaged in a state where the detachably mounted support part is inserted and supported in the direction of the other side that it is fixed at the ventilation grill; and an elastic fixing member which is disposed at the top of the detachably mounted pressing part and is provided to be fixedly engaged to a portion protruding at one side of the detachably mounted support part and is able to fix the top of the elastic member which is inserted into one side of the detachably mounted support part, thus supplying the elastic force of the elastic member to the detachably mounted pressing part.

According to at least one embodiment, the mounting part may include a support body which is disposed at one side of the detachably mounted pressing part and is provided in a plate shape to be inserted and accommodated in the detachably mounted pressing part when installing the mounting part; an angle adjusting ball which is disposed at one side of the mounting support body and is connected to a support connection bar protruding at one side of the mounting support body and is configured in a ball shape to support the adjustment of the angle; a mounting body which is disposed at one side of the mounting support body, wherein a mounting space to mount the mounted thing is formed at one side surface, and a ball insertion groove is formed at the other side for a part of the angle adjusting ball to be inserted and supported, thus adjusting angle; a mounting protrusion which is disposed protruding at a lower portion of one side surface of the mounting body and protrudes in the direction of one side at a lower portion of the mounting space and protrudes to support a lower portion thereof when mounting the mounted thing; and a pair of mounting pressing parts which are disposed at both sides of the mounting body and positions at both sides in the mounting space, and they are connected operating in cooperation with each other while maintaining a predetermined interval with the aid of an elastic force, wherein if the mounted thing is mounted after moved in the direction of one side between both sides when mounting the mounted thing, it is pressed and supported as the interval is contracted by the elastic force.

According to at least one embodiment, the mounting pressing part may include a pair of mounting pressing members which are disposed in a pair at both sides of the mounting body and position at both sides of the mounting space and are installed in a pair to press and support both side surfaces of the mounted thing; a pressing operation member which is disposed protruding intersecting above and below in the center in the direction where a pair of the mounting pressing members are being opposite to each other, wherein an operation toothed gear is provided in the direction that they are opposite to each other above and below as it position at the other side of the mounting body; an operation gear which is disposed rotatable in the center of the other side surface of the mounting body and is tooth-engaged with the operation toothed gear of the pressing operation body which are disposed intersecting to be opposite above and below, whereby the space pressed against both side surfaces of the mounted thing can be adjusted as a pair of the mounting pressing members operate in cooperation; and an operation elastic member which is disposed to be elastically supported at the protruding ends of the pressing member which are disposed intersecting above and below and is able to elastically support the portions between the mounting body and the pressing operation member for the interval between a pair of the mounting pressing members to be elastically maintained, wherein the operation elastic member is able to elastically support in a state where the interval of the user's manipulation has been adjusted when mounting the mounted thing.

According to at least one embodiment, a pair of the mounting pressing members include a pressing inclination part the cross section area of which increases in the direction from the other side to one side, wherein one side direction protrudes in the directions which are opposite to each other when supporting both side surfaces of the mounted thing with the aid of an elastic force, whereby the mounted thing can be prevented from separating in the direction of one side.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a partially disassembled perspective view illustrating an installation state of a mounting device for a vehicle according to an embodiment of the present invention.

FIG. 2 is a disassembled perspective view illustrating a detachably mounted support part and an elastic part which are major components of a mounting device for a vehicle in FIG. 1.

FIG. 3 is a perspective view illustrating a detachably mounted pressing part which is a major component of a mounting device for a vehicle in FIG. 1.

FIG. 4 is a bottom surface perspective view illustrating a bottom surface of a detachably mounted pressing part which is a major component of a mounting device for a vehicle in FIG. 4.

FIG. 5 is a backside perspective view illustrating the backsides of a mounting part and a mounting pressing part which are major components of a mounting device for a vehicle in FIG. 1.

FIG. 6 is an operation state view illustrating an operation state of a mounting part and a mounting pressing part which are major components of a mounting device for a vehicle in FIG. 1.

FIG. 7 is a use state view illustrating a state where an interval is widened by pressing the position which is elastically supported by an elastic part so as to mount, to a ventilation grill, a mounting device for a vehicle in FIG. 1.

FIG. 8 is a use state view illustrating a state where an elastic part of a mounting device for a vehicle in FIG. 7 is pressed, causing an interval widened, and is inserted supported in a ventilation grill.

FIG. 9 is a use state view illustrating a state where a mounting device for a vehicle is mounted at a ventilation grill as the interval which has widened by the elastic part contracts if a pressing force of an elastic force is removed in a state where a mounting device for a vehicle in FIG. 8 has been inserted supported in a ventilation grill.

### DETAILED DESCRIPTION

The preferred embodiments of the present invention will be described with reference to the accompanying drawings so that a person having ordinary skill in the art could implement easily.

Throughout the descriptions in conjunction with the embodiments, the descriptions on the technical contents which are previously known in the corresponding technical field and are not directly related with the present invention will be omitted, whereby the subject matters of the present invention can be understood clarified, without making unclear them, in such a way to omit the unnecessary descriptions.

For the same way, a part of components in the accompanying drawings may be illustrated exaggerated, omitted or schematic. Moreover, the dimension of each component is not intended to show its actual dimension. The same or corresponding components in each drawing are given the same reference numbers.

The present invention will be described in conjunction with the drawings which are provided to illustrate and describe the mounting device for a vehicle according to an embodiment of the present invention.

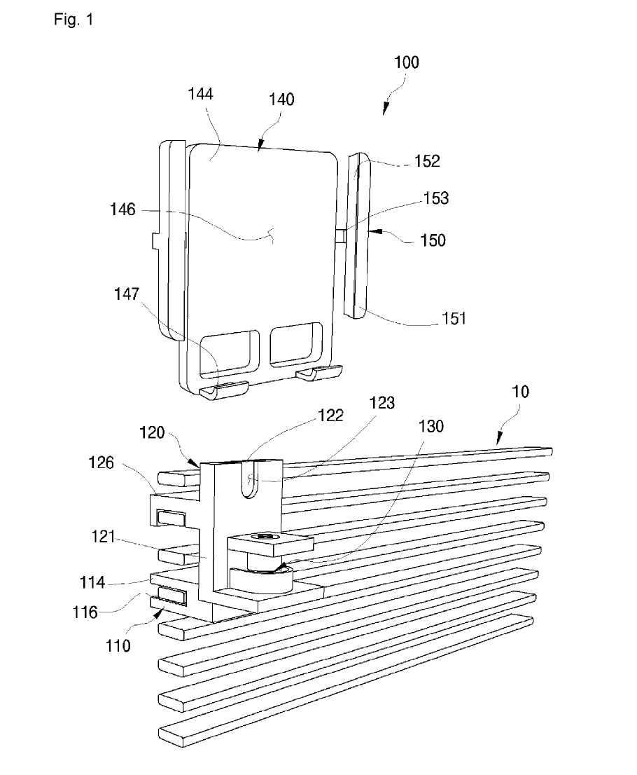

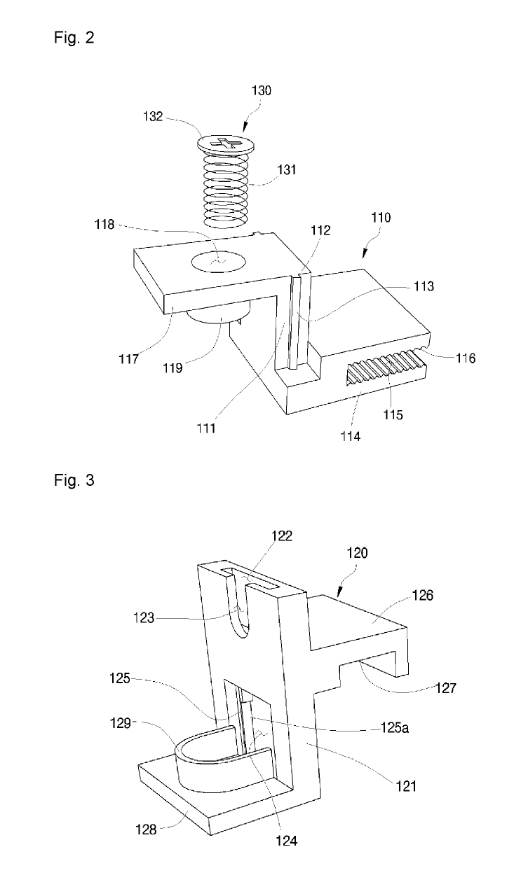

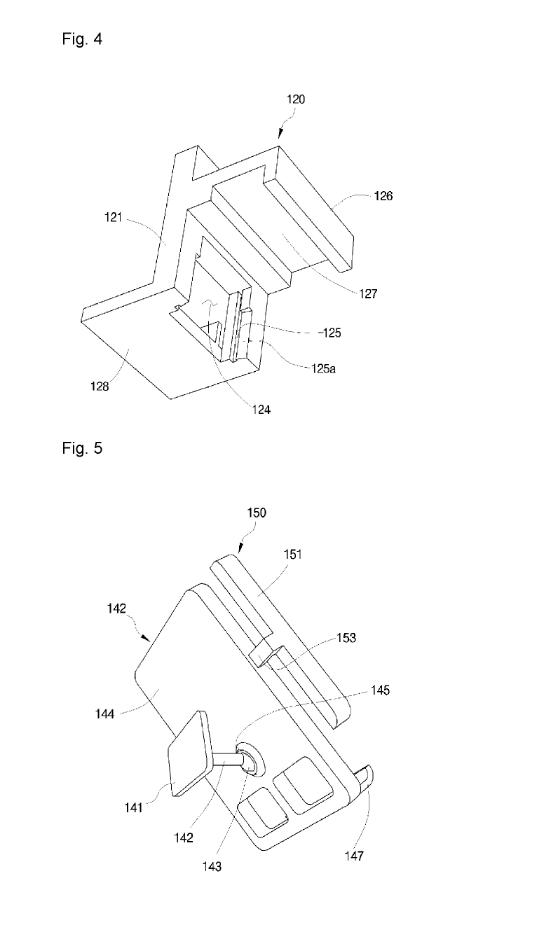

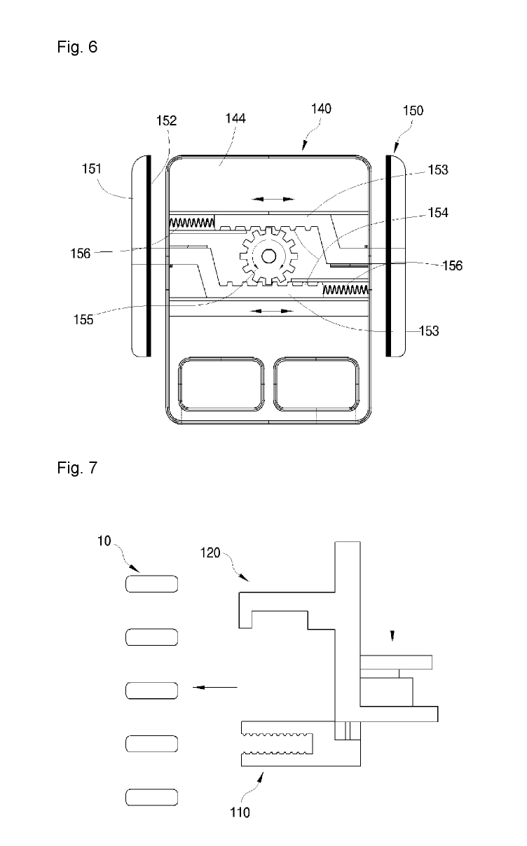

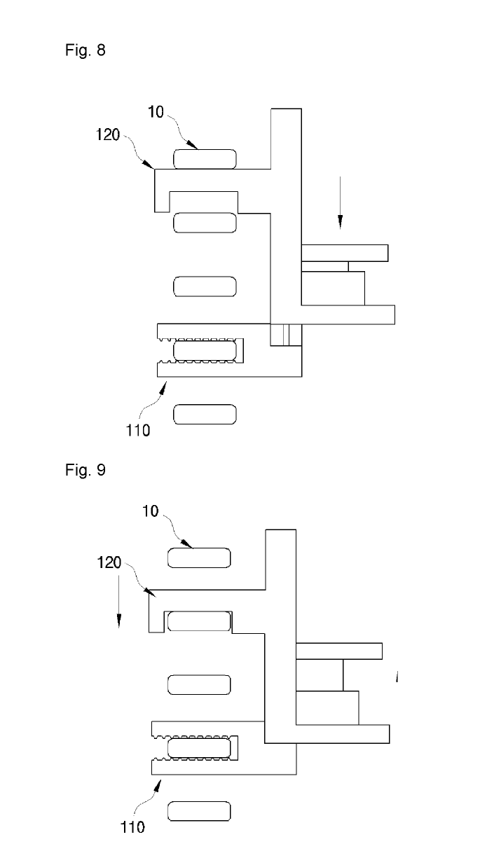

FIG. 1 is a partially disassembled perspective view illustrating an installation state of a mounting device for a vehicle according to an embodiment of the present invention. FIG. 2 is a disassembled perspective view illustrating a detachably mounted support part and an elastic part which are major components of a mounting device for a vehicle in FIG. 1. FIG. 3 is a perspective view illustrating a detachably mounted pressing part which is a major component of a mounting device for a vehicle in FIG. 1. FIG. 4 is a bottom surface perspective view illustrating a bottom surface of a detachably mounted pressing part which is a major component of a mounting device for a vehicle in FIG. 4. FIG. 5 is a backside perspective view illustrating the backsides of a mounting part and a mounting pressing part which are major components of a mounting device for a vehicle in FIG. 1. FIG. 6 is an operation state view illustrating an operation state of a mounting part and a mounting pressing part which are major components of a mounting device for a vehicle in FIG. 1. FIG. 7 is a use state view illustrating a state where an interval is widened by pressing the position which is elastically supported by an elastic part so as to mount, to a ventilation grill, a mounting device for a vehicle in FIG. 1. FIG. 8 is a use state view illustrating a state where an elastic part of a mounting device for a vehicle in FIG. 7 is pressed, causing an interval widened, and is inserted supported in a ventilation grill. FIG. 9 is a use state view illustrating a state where a mounting device for a vehicle is mounted at a ventilation grill as the interval which has widened by the elastic part contracts if a pressing force of an elastic force is removed in a state where a mounting device for a vehicle in FIG. 8 has been inserted supported in a ventilation grill.

Referring to FIGS. 1 to 9, the mounting device 100 for a vehicle according to an embodiment of the present invention is directed to a device which, in general, can be mounted at or demounted from, by a user's manipulation, a ventilation grill 10 which is equipped with a plurality of bars so as to supply, into the inside of a vehicle, an external air, a cooled air from an air conditioner, and a heated air from a heater while the direction of such air is being changed, whereby an electronic instrument, for example, a cellular phone, a navigation device, etc. and a predetermined accessory mounted thing, for example, a perfume, etc.

The mounting device for a vehicle 100 may include, but is not limited thereto, a detachably mounted support part 110 which positions at one side of a ventilation grill 10 when it is engaged to the ventilation grill 10 of a vehicle and is inserted supported in place, a detachably mounted pressing part 120, an elastic part 130, a mounting part 140, and a mounting pressing part 150. The detachably mounted support part 110 may include, but is not limited to, a support body 111 which positions at one side when it is installed at the ventilation grill 10, a slide protrusion 112, a support bracket 114, a support protrusion 116, an elastic support bracket 117, and an elastic support member 119.

The support body 111 is disposed at one side when it is installed at the ventilation grill 10 and may be inserted inside of the detachably mounted pressing part 120 and can slide upward or downward. The support body 111 may be disposed installed at one side where a mounted thing is installed in the ventilation grill 10.

The slide protrusion 112 is protruding from both sides of the support body 111 and is disposed protruding so as to guide it which is inserted in the detachably mounted pressing part 120 and moves upward or downward at both sides of the support body 111. The slide protrusion 112 is disposed protruding so as to guide a slide movement in upward or downward directions in the inside of the detachably mounted pressing part 120 and is inserted when the support body 111 is installed inside of the detachably mounted pressing part 120, thus guiding the sliding in upward or downward direction with the detachably mounted pressing part 120.

A protrusion inclination part 113 is formed at both sides of the slide protrusion 112, wherein the protrusion inclination part 113 is formed inclined for the cross section area to decrease in a direction from the other side to one side at each protruding position. It is inclined for the sake of an easier engagement when inserted and engaged, for the slide protrusion 112 to slide against the detachably mounted pressing part 120.

The support bracket 114 is disposed protruding toward other side at a lower portion of the support body 111 and includes a support space 115 into which it is inserted and supported when installing at the ventilation grill 10, wherein the other side direction is open, and one side and upper and lower portions thereof are closed. The support bracket 114 is disposed protruding toward other side which corresponds to the direction of the ventilation grill 10 at a lower portion of the support body 11, wherein the other side direction is open, into which a bar-shaped ventilation grill 10 is inserted, and a support space 115 may be formed, which is formed closed to support one side and upper and lower portions thereof when inserting in the ventilation grill 10. In this way, a supporting force to support the weight of the mounted thing can be enhanced by supporting the upper and lower portions and one side thereof when being supported against the ventilation grill 10 with the aid of the detachably mounted support part 110.

The support protrusion 116 is disposed protruding inside of the support bracket 114, while protruding in the direction where it faces each other above and below in the inside of the support space 115, and a protruded portion may be hooked and supported when inserting into the ventilation grill 10, thus preventing any separation, by which a support force can be enhanced.

The elastic support bracket 117 is disposed protruding, in the direction of one side, at the top of the support body 111 and may position at the top of the elastic part 130 and is elastically supported.

In a state where the elastic part 130 has been inserted in the center of the elastic support bracket 117, an elastic insertion hole 118 may be formed for the top thereof to pass and be fixed. The elastic support bracket 117 is disposed protruding in the direction of the upper position at one side where the elastic part 130 is installed. In a state that it is inserted in the elastic insertion hole 118, it is engaged to and supported by the elastic insertion hole 118, thus supporting the top of the elastic part 130 which is able to provide elastic force to the detachably mounted pressing part 120.

The elastic support member 119 is disposed protruding in the downward direction of the elastic support bracket 117, while covering a part of the top of the outer circumference of the elastic part 130, thus preventing its external separation. The elastic support member 119 is disposed protruding downward at the elastic support bracket 117 to support the top of the elastic part 130 installed at a lower portion thereof, thus preventing its separation.

The detachably mounted pressing part 120 may include a pressing body 121 which is inserted for the support body 111 to slide, a pressing bracket 126, a pressing operation member 128, and an operation bracket 129. The pressing body 121 may be disposed at one side when being installed at the ventilation grill 10. A mounting part 140 is inserted and mounted on its top, and the support body 111 may be elastically supported at a lower portion with the aid of the elastic part 130 and may be supported slidable upward or downward.

An accommodation space 122 may be formed on the top of the pressing body 121 the top of which is open, wherein the mounting part 140 is inserted and supported at a part of the inside thereof. The accommodation space 122 may be provided in a space shape in which the mounting part 140 at which a mounted thing will be mounted, is inserted and supported.

An accommodation insertion groove 123 may be formed at one side of the pressing body 121, wherein a part thereof is open in the direction of one side at one side of the accommodation space 122, and a connected portion of the mounting part 140 is inserted in the accommodation insertion groove 123. The accommodation insertion groove 123 may be provided a groove shape, wherein a part of the top is open at one side of the accommodation space 122, a portion to which the mounting part 140 is connected, is inserted into the accommodation insertion groove 123.

A slide space 124 may be formed at the pressing body 121, wherein a part thereof passes from bottom to top, and the support body 111 is inserted therein to slide upward or downward, and a groove-shaped slide groove 125 in which the slide protrusion 112 is inserted, is formed at the slide space 124, so as to guide upward or downward movements with respect to both sides which are formed opposite to each other. If it is inserted in the slide space 124 which is partially passed through from the bottom to the top of the pressing body 121 for the support body 111 to slide upward or downward, the slide protrusion 112 is inserted in the slide groove 125, thus guiding the upward or downward slides.

In the slide groove 125 into which the slide protrusion 112 of the pressing body 121 is inserted, a groove inclination part 125a may be formed, the cross section area of which increases from the other side to one side so as to correspond to the protrusion inclination part 113. If the support body 111 is slide-engaged to the pressing body 121, the protrusion inclination part 113 will match with the groove inclination part 125a, and the slide protrusion 112 will press the slide groove 125 from the other side to one side, so it can be directly inserted and installed. More specifically, the protrusion inclination part 113 and the groove inclination part 125a may be formed at the slide protrusion 112 and the slide groove 125 which are guided for the upward or downward slide movements. If the support body 111 is slide-engaged to the pressing body 121, the device can be easily installed by directly pressing the inclined position.

The pressing bracket 126 is disposed protruding toward the other side at the top of the pressing body 121. It may position at the opposite top of the support bracket 114 and can slide upward or downward together with the pressing body 121, so it can be inserted into the ventilation grill 10 with the aid of an elastic force of the elastic part 130, thus being pressed and supported. The pressing bracket 126 may allow to maintain the state supported by a pressing pressure while pressing it downward from top to bottom with the aid of the elastic force of the elastic part 130 in a state where the support bracket 114 is supporting the lower ventilation grill 10 when mounting the mounting device 100 at the ventilation grill 10. When detaching the device, the pressing body 121 is slide in the upward direction by the user's manipulation, so it can be easily detached in a state where the pressing pressure has been removed.

A pressing space 127 may be formed at the lower surface of the pressing bracket 126, wherein the lower side thereof is open, and both sides and the top are closed, so the ventilation grill 10 can be inserted. The supporting force of the pressing space 127 can be enhanced since it contacts or supports the top and both side surfaces which are pressed in a state where the ventilation grill 10 has been inserted when engaging the mounting device 100.

The pressing operation member 128 is disposed protruding in the direction of one side at a lower portion of the pressing body 121 and may position at a lower portion being opposite to the elastic support bracket 117 and can slide upward or downward together with the pressing body 121 and can be elastically supported at a lower portion of the elastic part 130, thus providing a pressing force which allows to press downward the pressing bracket 126.

The pressing operation member 128 is elastically supported at a lower portion of the elastic part 130 supported by the elastic support bracket 117 and may be configured to provide an elastic force which allows to move downward the pressing body 121 which is slide-engaged to the support body 111. If the mounting device 100 is detached, when a user manipulates to compress the elastic part 130 in a state where the user is holding the pressing operation member 128 together with the elastic support bracket 117, the elastic force will be removed, which has been applied downward for the elastic support bracket 117 to move upward and for the pressing body 121 to move upward together with the elastic support bracket 117.

The operation bracket 129 is disposed protruding upward at the pressing operation member 128. Since a part of the lower portion is covered by an outer circumference of the elastic part, the operation bracket 129 is prevented from separating to the outside.

The elastic part 130 may include an elastic member 131 interposed between the elastic support bracket 117 and the pressing operation member 128, and an elastic fixing member 132. The elastic member 131 may be disposed to elastically support the elastic support bracket 117 and the pressing operation member 128. It is configured to provide a pressing force which allows to press the pressing operation member 128 slide-engaged in a state where it is inserted and supported in the elastic insertion hole 118 of the elastic support bracket 117. The elastic force which has been applied to the pressing operation member 128 will be transferred to the pressing bracket 126 via the pressing body 121 which is being slided, thus fixedly pressing the ventilation grill 10.

The elastic fixing member 132 is disposed to position at the elastic insertion hole 118 of the elastic support bracket 117 and is configured to fixedly engage with the elastic insertion hole 118 of the elastic support bracket 117, by which the elastic force of the elastic member 131 inserted in the elastic insertion hole 118 can apply to the elastic support bracket 117.

The mounting part 140 may include a mounting support body 141 inserted and installed at the pressing body 121, an angle adjusting ball 143, a mounting body 144, and a mounting protrusion 147. The mounting support body 141 is inserted and supported at the accommodation space 122 of the pressing body 121 so as to mount a mounted thing, and may be configured in a plate shape for it to be separated when it is disassembled.

The angle adjusting ball 143 may be configured in the form of a ball, wherein the angle adjusting ball 143 may be disposed at one side of the mounting support body 141 and may protrude at one side of the support body 111 and may be inserted in the accommodation insertion groove 123 when inserting the pressing body 121 and may be connected via a support connection bar 142 which protrudes at one side, thus assisting in the adjustment of an angle.

The mounting body 144 may be disposed at one side of the mounting support body 141, wherein a mounting space 146 to mount a mounted thing is formed at one side surface, and a ball insertion groove 145 may be formed at the other side for the angle adjustment ball 143 to be supported angle-adjustable as a part of the angle adjustment ball 143 is inserted therein. The mounting body 144 may be configured so that the angle can be adjusted as it rotates about the angle adjusting ball 143 in a state where a part of the angle adjustment ball 143 is inserted and supported in the ball insertion groove 145 formed at the other side surface, and a mounted thing has been mounted.

The mounting protrusion 147 may be disposed protruding from a lower portion of one side surface of the mounting body 144, and it may protrude in one direction at a lower portion of the mounting space 146 and may protrude to support a lower portion when a mounted thing is mounted. The mounting protrusion 147 may be provided in a protrusion form which allows an engaging and support so as to prevent the mounted thing mounted at one side of the mounting body 144 from separating downward.

The mounting pressing part 150 may include a mounting pressing member 151 which is able to press and support the mounted thing at both sides in the direction of one side of the mounting body 144, a mounting pressing operation member 153, an operation gear 155, and an operation elastic member 156. The mounting pressing member 151 may be disposed in a pair at both sides of the mounting body 144 and may position at both sides of the mounting space 146, thus pressing and supporting both sides surfaces of the mounted thing. The mounting pressing member 151 was supported as it is pressed in opposite directions from both side surfaces of the mounting space 146, thus enhancing the supporting force of the mounted thing.

Moreover, a pressing inclination part 152 the cross section area of which increases in the direction of one side from other sides, may be formed at a pair of mounting pressing members 151, so one side direction may protrude in the opposite directions when it is supported at both sides surfaces of the mounted thing with the aid of an elastic force, whereby the mounted thing can be prevented from escaping in the direction of one side.

The mounting pressing operation member 153 may protrude intersecting each other above and below to the center from the direction where a pair of the mounting pressing members 151 are disposed opposite to each other, and an operation tooted gear 154 may position at the other side of the mounting body 144 in the direction that they are opposite to each other above and below. The mounting pressing operation member 153 is configured in such a way that the operation toothed gear 154 is tooth-engaged with the operation gear 155 at the surfaces which are formed opposite to each other as they are protruding from the other side surface of the mounting body 144 while intersecting above and below at one side and the other side at a pair of the mounting pressing members 151, whereby a pair of the mounting pressing members 151 can operation in cooperation therewith.

The operation gear 155 may be installed in such a way that it is disposed rotatable in the center of the other side surface of the mounting body 144 and is tooth-engaged with the operation toothed gear 154 of the mounting pressing operation members 153 which are disposed intersecting opposite to each other above and below, so a pair of the mounting pressing members 151 can operate in cooperation therewith, whereupon the space pressed against both side surfaces of the mounted thing can be adjusted. The operation gear 155 may be tooth-engaged via an operation toothed gear 154 with the mounting pressing operation member 153 which is disposed protruding from a pair of the mounting pressing members 151. If the mounting pressing member 151 between a pair of the mounting pressing members 151 and of one side moves, the mounting pressing member 151 of the other side will move together, thus adjusting the space supported against both sides surfaces of the mounting pressing member 151.

The operation elastic member 156 may be disposed elastically supported at each protruding end of the mounting pressing operation members 153 which are disposed intersecting each other above and below and is able to elastically support the portions between the mounting body 144 and the mounting pressing operation member 153 so as to maintain, with an elastic force, the interval between a pair of the mounting pressing members 151, thus elastically supporting in a state where the interval has been adjusted by a user's manipulation when mounting the mounted thing. The operation elastic member 156 is disposed protruding from a pair of the mounting pressing operation members 153 and is installed for each end which position intersecting each other to be elastically supported by the mounting body 144, whereby a pair of the mounting pressing members 151 can maintain intervals with the aid of an electric force.

If a user moves, in an outward direction, one mounting pressing member 151 between a pair of the mounting pressing members 151, the mounting pressing member 151 of the other side will move outward since it is configured to operate via the operation gear 155, so the interval between a pair of the mounting pressing members 151 elastically supported by the operation electric member 156 is widened. In a state where both intervals are widened, if the force allowing to move is removed after the mounted thing has been accommodated, the widened interval which has been widened by the elastic force of the operation elastic member 156, becomes contracted, thus pressing both sides and then supporting the mounted thing. More specifically, it can move together when the mounting pressing member 151 of one side between a pair of the mounting pressing members 151 moves, and the moving force is removed, both side surfaces can be supported together by the pressing force which generates due to an elastic force. In this way, the mounted thing can be mounted with a user's one touch action using one hand, which makes it possible to enhance any convenience when mounting.

In the mounting device for a vehicle according to an embodiment of the present invention, a detaching and attaching can be carried out based on an indirect elastic force transfer to a detaching and attaching since an elastic force can be provided to two members where the detached and attached portions at a ventilation grill of a vehicle are intersecting, by means of which a user can stably detach or attach, with a smaller force, the mounting device of the present invention at the ventilation grill, thus enhancing convenience when in use, and any detaching due to a predetermined external force can be prevented.

Moreover, in the mounting device for a vehicle according to the present invention, two intersecting members are configured to slide at a intersecting position, and one sliding side is inserted into a ventilation grill, and an elastic member is installed at the other sliding side, for which the sliding one side and the other sliding side can receive force in the directions opposite to each other. In this way, an opening force due to the elasticity of the other side can be converted into a clamping force of the one side, thus indirectly fixing the mounting device, whereupon the detaching and attaching can be carried out with a smaller force, which may lead to an improved convenience when in use.

Furthermore, in the mounting device for a vehicle according to the present invention, one sliding side detached or attached based on an indirect elasticity is pressed to be clamped in a state where it is plain-contacting with a ventilation grill, so it is possible to enhance a support force by which the mounting device can be supported substantial after mounting.

In the mounting device for a vehicle according to the present invention, a mounting part which is supporting a mounted thing toward the other side of a detaching and attaching portion engaged to a ventilation grill is equipped with mounting support members which operates in cooperation with each other while elastically maintaining a predetermined interval toward both side surfaces. In this state, a mounted thing can be supported the intervals are contracted after the mounted thing has been inserted in a state where the intervals were widened as both sides operated in cooperation with each other due to the movement to one side. The mounted thing, therefore, can be easily mounted with one action.

In the mounting device for a vehicle according to the present invention, a mounting and supporting part by which a mounted thing is mounted, can be maintained after the angle has been adjusted by the manipulation of a user, the user is able to easily look at the mounted thing, thus enhancing convenience when in use.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A mounting device for a vehicle which is installed at a ventilation grill of a vehicle to mount a predetermined mounted thing, comprising:
a detachably mounted support part which is disposed to be inserted and supported when the detachably mounted support part is installed at the ventilation grill, and it positions at the other side of the ventilation grill, and a portion protruding in the direction of one side at a lower portion thereof is inserted and supported in the ventilation grill, wherein the detachably mounted support part is provided protruding in the direction of the other side at the top thereof;
a detachably mounted pressing part which is disposed to slide upward or downward, while intersecting with the detachably mounted support part, and is engaged to slide with the detachably mounted support part, wherein one side thereof is protruding to press the ventilation grill at the top which is opposite to the detachably mounted support part, and it is slide-engaged protruding at a lower portion which is opposite to the detachably mounted support part at a lower portion in the direction of the other side, so one side and the other side thereof are disposed intersecting each other to be opposite to the detachably mounted support part;
an elastic part which is disposed elastically supporting the detachably mounted support part and the detachably mounted pressing part, while elastically supporting a portion which protrudes upward or downward of the other sides of the detachably mounted support part and the detachably mounted pressing part, whereby one side of the detachably mounted pressing part allows to provide a pressing pressure which presses the ventilation grill; and
a mounting part which is disposed at one side of the detachably mounted pressing part, and is provided at the detachably mounted pressing part in such a way to be detached or attached by means of insertion, thus mounting a predetermined mounted thing.

2. The mounting device for a vehicle of claim 1, wherein the detachably mounted support part comprises:
a support body which is disposed at one side when it is installed at the ventilation grill and is inserted inside of the detachably mounted pressing part and is able to slide upward or downward;
a slide protrusion which is formed protruding at both sides of the support body and protrudes to guide the upward or downward movements as it is inserted in the detachably mounted pressing part at both sides of the support body, and the cross section area thereof contracts in the direction from the other side to one side, thus forming an inclined type protrusion inclination part which is inserted from the other side to one side into the detachably mounted pressing part;
a support bracket which is disposed protruding in the direction of other side at a lower portion of the support body, wherein the other side direction thereof is open, and one side and upper and lower sides thereof are closed, thus forming a support space to be inserted and supported when it is installed at the ventilation grill;
an elastic support bracket which is disposed protruding in the direction of one side at the top of the support body and positions at the top of the elastic part and is elastically supported, wherein the elastic support bracket has an elastic insertion hole formed in the center thereof, while passing through for the elastic part to be inserted, and the top thereof is fixed; and
an elastic support member which is protruding in the downward direction of the elastic support bracket and is configured to cover a part of the top at an outer circumference of the elastic part, thus preventing an outward separation thereof.

3. The mounting device for a vehicle of claim 2, further comprising a support protrusion which is formed protruding inside of the support bracket, and protrudes in the direction to be opposite to each other above and below inside of the support space, wherein a protruding portion is hooked and supported when inserting it into the ventilation grill, thus preventing any separation while enhancing a supporting force.

4. The mounting device for a vehicle of claim 1, wherein the detachably mounted pressing part comprises:
a pressing body which is disposed at one side when it is installed at the ventilation grill, and has an accommodation space, the top of which is open, wherein the mounting part is inserted and supported at a part of the inside thereof, and an accommodation insertion groove into which a part connected with the mounting part is inserted, is formed at one side of the accommodation space, with a part thereof being open in the direction of one side, and a slide space a part of which is formed passing through from bottom to top, is formed, wherein the detachably mounted support part is inserted therein to slide upward or downward, and a groove shaped slide groove is provided, into which the detachably mounted support part is inserted, so as to guide it moves upward or downward at both sides which are opposite to each other in the slide space, and a cross section area thereof increases from the other side to one side at the slide groove, thus forming a groove inclination part which is configured to hook and support when the detachably mounted support part is inserted from the other side to one side and is installed;
a pressing bracket which is disposed protruding in the direction of the other side at the top of the pressing body and positions at the top which is opposite to the other side of the detachably mounted support part and slides upward or downward together with the pressing body and is configured to be inserted, pressed and supported in the ventilation grill with the aid of an elastic force of the elastic part, wherein a pressing space is formed at the lower surface thereof, and the lower side thereof is open, and both sides and upper side thereof are closed, and the ventilation grill is inserted into the pressing space;
a pressing operation member which is disposed protruding in the direction of one side thereof at a lower portion of the pressing body, and positions at a lower portion which is opposite to one side of the detachably mounted support part and slides upward or downward together with the pressing body, and is elastically supported by a lower portion of the elastic part, wherein the pressing operation member is able to generate a pressing pressure which allows to press downward the pressing bracket; and
an operation bracket which is disposed protruding in the upward direction of the pressing operation member, wherein the operation bracket is able to prevent a separation to the outside since it covers a part of a lower portion of the outer circumference of the elastic part.

5. The mounting device for a vehicle of claim 1, wherein the elastic part comprises:
an elastic member which is disposed to elastically support a portion which protrudes at one side of each of the detachably mounted support part and the detachably mounted pressing part and is able to generate a pressing force which allows to press the detachably mounted pressing part which is slide-engaged in a state where the detachably mounted support part is inserted and supported in the direction of the other side that it is fixed at the ventilation grill; and
an elastic fixing member which is disposed at the top of the detachably mounted pressing part and is provided to be fixedly engaged to a portion protruding at one side of the detachably mounted support part and is able to fix the top of the elastic member which is inserted into one side of the detachably mounted support part, thus supplying the elastic force of the elastic member to the detachably mounted pressing part.

6. The mounting device for a vehicle of claim 1, wherein the mounting part comprises:
a support body which is disposed at one side of the detachably mounted pressing part and is provided in a plate shape to be inserted and accommodated in the detachably mounted pressing part when installing the mounting part;
an angle adjusting ball which is disposed at one side of the mounting support body and is connected to a support connection bar protruding at one side of the mounting support body and is configured in a ball shape to support the adjustment of the angle;
a mounting body which is disposed at one side of the mounting support body, wherein a mounting space to mount the mounted thing is formed at one side surface, and a ball insertion groove is formed at the other side for a part of the angle adjusting ball to be inserted and supported, thus adjusting angle;
a mounting protrusion which is disposed protruding at a lower portion of one side surface of the mounting body and protrudes in the direction of one side at a lower portion of the mounting space and protrudes to support a lower portion thereof when mounting the mounted thing; and
a mounting pressing parts which are disposed in a pair at both sides of the mounting body and positions at both sides in the mounting space, and they are connected operating in cooperation with each other while maintaining a interval with the aid of an elastic force, wherein if the mounted thing is mounted after moved in the direction of one side between both sides when mounting the mounted thing, it is pressed and supported as the interval is contracted by the elastic force.

7. The mounting device for a vehicle of claim 6, wherein the mounting pressing part comprises:
a pair of mounting pressing members which are disposed in a pair at both sides of the mounting body and position at both sides of the mounting space and are installed in a pair to press and support both side surfaces of the mounted thing;
a pressing operation member which is disposed protruding intersecting above and below in the center in the direction where a pair of the mounting pressing members are being opposite to each other, wherein an operation toothed gear is provided in the direction that they are opposite to each other above and below as it position at the other side of the mounting body;
an operation gear which is disposed rotatable in the center of the other side surface of the mounting body and is tooth-engaged with the operation toothed gear of the pressing operation body which are disposed intersecting to be opposite above and below, whereby the space pressed against both side surfaces of the mounted thing can be adjusted as a pair of the mounting pressing members operate in cooperation; and
an operation elastic member which is disposed to be elastically supported at the protruding ends of the pressing member which are disposed intersecting above and below and is able to elastically support the portions between the mounting body and the pressing operation member for the interval between a pair of the mounting pressing members to be elastically maintained, wherein the operation elastic member is able to elastically support in a state where the interval of the user's manipulation has been adjusted when mounting the mounted thing.

8. The mounting device for a vehicle of claim 7, wherein a pair of the mounting pressing members comprise a pressing inclination part the cross section area of which increases in the direction from the other side to one side, wherein one side direction protrudes in the directions which are opposite to each other when supporting both side surfaces of the mounted thing with the aid of an elastic force, whereby the mounted thing can be prevented from separating in the direction of one side.
